(19) United States
(12) Patent Application Publication
(10) Pub. No.: US 2005/0140296 A1
(43) Pub. Date: Jun. 30, 2005

(54) Mercury-free high-pressure gas discharge lamp

(76) Inventors: Michael Haacke, Aachen (DE); Ralf Muckel, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/503,461

(22) PCT Filed: Jan. 29, 2003
(86) PCT No.: PCT/IB03/00341

(30) Foreign Application Priority Data
Feb. 7, 2002 (DE) 102-04-925.4

(51) Int. Cl. H01J 17/20

(52) U.S. Cl. 313/574

(57) ABSTRACT

A high-pressure gas discharge lamp (HID [high intensity discharge] lamp) is described which is free from mercury and suitable in particular for use in automotive technology. The lamp is particularly remarkable in that a rise in temperature of the coldest (lowermost) bottom regions (10) is achieved by an asymmetrical electrode arrangement, such that the light-generating substances accumulated in said regions enter the gas phase in a sufficient quantity upon switching-on of the lamp. The temperature of the hottest (uppermost) wall regions (13) is not raised thereby, indeed, it may even be reduced. An essential advantage of this lamp is that its external shape, its dimensions, and the electrodes (3) themselves need not be changed when the lamp is operated in a horizontal position with vertically aligned pinches (5), while the electrodes (3) are fastened each to a metal foil (4) in a suitable downwardly-shifted position.

The invention relates to a high-pressure gas discharge lamp (HID [high intensity discharge] lamp) which is in particular free from mercury and suitable for use in automobile technology.

Conventional high-pressure gas discharge lamps contain on the one hand a discharge gas (usually a metal halide such as sodium iodide or scandium iodide) which is the actual light-emitting material (light generator), and on the other hand mercury which primarily serves to form a voltage gradient and has the essential function of enhancing the efficacy and burning voltage of the lamp.

Lamps of this kind have come into widespread use because of their good properties and they are increasingly applied also in the field of automobile technology. It is also partly required in particular for this application, however, that the lamps should contain no mercury for environmental reasons.

A general problem with mercury-free lamps is, however, that a lower burning voltage is obtained for a given lamp power in continuous operation, and accordingly a higher lamp current and a lower luminous efficacy.

It is an object of the invention, therefore, to provide a high-pressure gas discharge lamp which has a gas filling free from mercury and is nevertheless capable of achieving a luminous efficacy which corresponds substantially to that of lamps that do contain mercury. Furthermore, the object is to provide a high-pressure gas discharge lamp which has a higher burning voltage with a mercury-free gas filling than is normally achievable with mercury-free lamps.

In particular, the object is to provide a high-pressure gas discharge lamp with which at least one of the two objects (higher luminous efficacy and higher burning voltage) mentioned above can be achieved without the necessity of increasing lamp power or changing the external dimensions of the lamp's outer bulb.

A further object is to provide a mercury-free high-pressure gas discharge lamp which has a lumen maintenance usual for automotive applications, i.e. in which the luminous decrement during lamp life is similar to that in lamps with mercury.

Finally, a high-pressure gas discharge lamp is to be provided which is suitable in particular for use in the automotive field.

The object is achieved according to claim 1 by means of a mercury-free high-pressure gas discharge lamp with a discharge vessel, with pinches, and with at least one metal foil of which a portion extends in vertical direction when the lamp is in the horizontal operational position and to which an electrode is fastened, wherein the distance from the electrode tip to a bottom region of the discharge vessel, on which light-generating substances accumulate in the switched-off state of the lamp, is dimensioned such that said substances enter the gas phase in a sufficient quantity owing to heating upon switching-on of the lamp.

It was found that the lamp properties, especially as regards a burning voltage and a luminous efficacy which are as high as possible, are better in proportion as the quantity of the light-generating substances entering the gas phase is greater. The distance is accordingly made so small that this quantity is sufficiently great for achieving desired lamp properties, or lamp properties comparable to those of lamps containing mercury.

It should obviously be taken into account here that the bottom region mentioned above must not heat up so strongly that defects or damage (crystallization, deformation, cracks) arise in said bottom region which could detract from lamp life. For this reason, the distance is made only so small as is necessary for achieving a sufficient evaporation of the light-generating substances.

A further advantage of this solution is that the components of the lamp itself, i.e. in particular the size and shape of the discharge vessel, of the pinches, and of the electrodes, can remain unchanged in comparison with known lamps, so that considerable technical advantages in manufacture, and thus economic advantages can be obtained with respect to other embodiments, which often require far-reaching changes in the lamp shape or its internal components (for example bent electrodes).

It is furthermore advantageous, finally, that the arrangement of the electrodes mentioned above raises the temperature of the coldest spots in the discharge vessel without a rise in the maximum temperature (i.e. of the upper wall regions in the operational position). The maximum temperature may even be reduced owing to a resulting distance of the electrode tips from said upper wall regions, so that the temperature drop across, and accordingly the maximum thermal load on the lamp (thermal stress) are reduced.

The electrode arrangement mentioned above has the result in particular that either mercury can be omitted without replacement, or that an alternative voltage-gradient generator less harmful to the environment can be used instead of mercury, for example a suitable metal halide, such that in any case the light-generating substances enter the gas phase in a sufficient quantity on account of the achieved higher temperature of said regions, i.e. in such a quantity that the luminous efficacy of the lamp and/or its burning voltage are raised in the desired manner thereby, i.e. they reach values comparable to those of lamps that do contain mercury.

Finally, this solution is also applicable to discharge lamps with gas fillings comprising mercury. The luminous efficacy of such lamps can be considerably enhanced thereby.

It should be noted here that DE-OS 25 35 922 and U.S. Pat. No. 4,001,623 disclose high-pressure gas discharge lamps in which the free tips of the electrodes are arranged below the longitudinal axis of the lamp, i.e. asymmetrically in the discharge space. There is a risk, however, in particular in the embodiment disclosed in the US-PS, that light-generating substances will enter the entry locations of the electrodes and thus the pinches, where they may cause damage through corrosion.

Furthermore, these lamps contain mercury in their gas fillings for achieving a sufficient luminous efficacy and burning voltage, and thus do not fulfill the above requirement for use in automotive technology. Finally, other particulars and requirements relevant to this application such as, for example, an unchanged external shape and external dimensions of the lamp, if at all possible, or the co-operation of a coating—if present—with the reflector are not fulfilled, so that these publications are not regarded as relevant.

The dependent claims relate to advantageous further embodiments of the invention.

The embodiment of claim 2 has the particular advantage that an excess quantity of light-generating substances may be introduced into the discharge vessel without the risk that the excess proportion of light-generating substances migrating owing to heating during switching-on of the lamp arrive at the entry locations in an appreciable quantity and can enter the pinches, where they could cause damage by corrosion or similar effects in the course of time.

Claim 3 specifies preferred types of barriers which are particularly simple to realize.

Claims 4 and 5 describe preferred methods of fastening the electrodes to the metal foil, which are comparatively easy to realize in manufacturing technology.

The embodiment of claim 6 renders it possible to obtain a particularly long lamp life.

Claim 7 relates to voltage-gradient generators (one of them being, for example, also zinc iodide) which may be used instead of mercury and with which a particularly good luminous efficacy can be achieved, while claim 8 describes a possibility of increasing the gas pressure, in particular for achieving a higher luminous efficacy and burning voltage.

The embodiment of claim 9 renders it possible to improve the protection of the entry locations of the electrodes and the pinches lying behind them against the light-generating substances.

Further particulars, characteristics, and advantages of the invention will become apparent from the following description of preferred embodiments, which is given with reference to the drawing, in which:

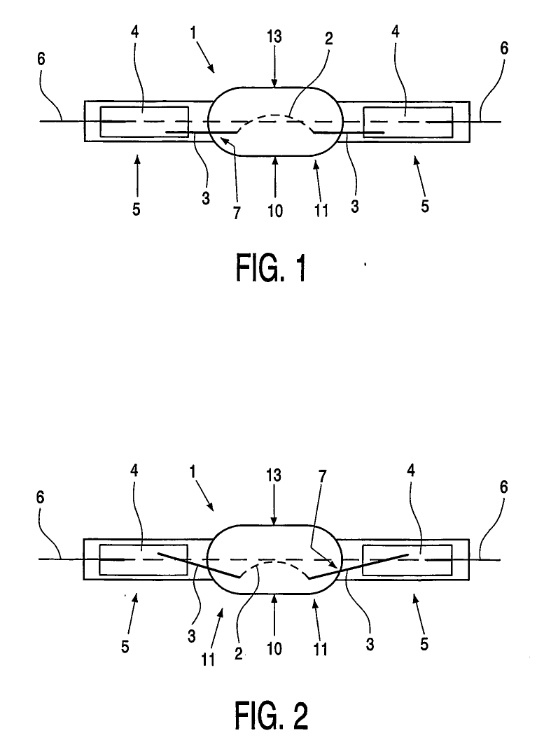

FIG. 1 is a diagrammatic side elevation of a first embodiment; and

FIG. 2 is a diagrammatic side elevation of a second embodiment.

FIGS. 1 and 2 show two high-pressure gas discharge lamps according to the invention in their horizontal burning positions. The lamps each comprise a discharge vessel 1 of quartz glass which encloses a discharge space and which merges at its mutually opposed ends into respective quartz glass portions (or pinches) 5.

The discharge space is filled with a gas which is composed of a discharge gas (light generator), which emits the light radiation through excitation or discharge, and preferably a voltage-gradient generator, both of which may be chosen from the group of metal halides.

The light-generating substances are, for example, sodium iodide and/or scandium iodide, while the voltage-gradient generator may be, for example, zinc iodide and/or other substances instead of mercury. Alternatively or additionally to the voltage-gradient generator, certain quantities of rare gases (for example xenon) may be introduced into the discharge space so as to increase the gas pressure and thus the luminous efficacy and the burning voltage further.

The free ends of electrodes 3 extend into the discharge space from the mutually opposed ends thereof, which electrodes are manufactured from a material with as high a melting temperature as possible, for example tungsten, while between the tips thereof an arc discharge (light arc) 2 is excited in the operational condition of the lamp.

The respective other ends of the electrodes 3 are each fastened to an electrically conductive tape or metal foil 4, in particular a molybdenum foil, through which an electrical connection between the connection terminals 6 of the discharge lamp and the electrodes 3 is achieved. These ends of the electrodes 3 and the electrically conductive foil 4 are embedded in the pinch 5.

The pinches 5, and thus also the metal foils 4 embedded therein, have a width which extends in vertical direction when the lamp is in the horizontal burning position as shown in FIGS. 1 and 2. This has the advantage that the shape and dimensions of the lamp need not be changed if the electrodes 3 are to be arranged such that at least their tips are as close as possible to the lowermost or bottom regions 10 in the operational position, i.e. those regions on which the light-generating substances accumulate in the switched-off state of the lamp.

A further advantage is that the dimensions of an outer bulb surrounding the lamp according to the invention need not be changed, which is of particular importance for the use of these lamps in motor vehicle headlights.

As was noted above, the gas filling of the high-pressure gas discharge lamps according to the invention preferably comprises one or several suitable metal halides instead of mercury as a voltage-gradient generator. These substances, however, have a comparatively low partial vapor pressure, so that it is necessary to change the temperature balance in the discharge vessel 1 for achieving substantially the same luminous efficacy of the lamp (luminous flux) as with the use of mercury, as well as a burning voltage which is as high as possible. During switching-on of the lamp, it is in particular the temperature of the light-generating substances accumulated in the solid state on the lowermost bottom regions 10 in the operational position in the switched-off state of the lamp which must be increased to such a degree that said substances will enter the gas phase in a sufficient quantity for achieving a desired, i.e. as high as possible luminous efficacy and burning voltage. An additional difficulty here is that these bottom regions 10 are the coldest regions in the operational state of the lamp.

It should also be noted that the change in the temperature balance must not give rise to such a high temperature that a crystallization or devitrification of the discharge vessel 1 made of quartz glass takes place. This relates in particular to the bottom regions 10 to be heated, on which the light-generating substances accumulate, as well as to the upper wall 13 which is exposed to a particularly strong heating owing to the strong convection inside the discharge space in the region above the arc discharge 2.

Finally, the temperature balance is to be changed without an increase in the lamp power, if possible.

All these preconditions can be fulfilled by the described shift in position of the electrodes 3 which is made possible by the changed burning position of the lamp.

In the first embodiment of the invention shown in FIG. 1, the electrodes are shifted over a certain distance parallel to the horizontal line of symmetry of the lamp in downward direction and thus fastened to the molybdenum foil 4. Said distance is chosen in particular in dependence on the curvature of the luminous arc 2 such that the temperature of the coldest (lowermost) bottom regions 10 of the discharge vessel rises to an extent as is necessary for a sufficient evaporation of the light-generating substances accumulated there upon switching-on of the lamp. If so desired, the width of the molybdenum foil may be increased so as to achieve this distance.

Alternatively or additionally to this measure, one or both electrodes 3 may be pointing obliquely downwards in the second embodiment of the invention shown in FIG. 2, so as to shift the electrode tip, and thus the arc 2, even further in downward direction. The width of the molybdenum foil is again dimensioned such that the electrodes can be securely fastened thereto.

The temperature at the upper wall regions 13 is not increased because of the increased distance of the luminous arc to these wall regions, or is even lowered, so that the thermal stresses and the accompanying load on the discharge vessel 1 are substantially reduced and a correspondingly longer lamp life is achieved. An optimum position of the electrode tips is achieved when on the one hand the light-generating substances accumulated on the lower wall portions are heated so strongly that they evaporate in a sufficient quantity after switching-on of the lamp, so as to achieve a desired, i.e. as high as possible luminous efficacy and burning voltage of the lamp, and on the other hand no excessive heating of the discharge vessel takes place so as to avoid damage that would shorten lamp life (defects, cracks in the discharge vessel wall), but instead as homogeneous as possible, or as symmetrical as possible a temperature distribution is present over the entire discharge vessel.

The bottom region 10, on which the light-generating substances accumulate when the lamp is switched off, is preferably separated from the entry locations 7 of the electrodes 3 into the pinches 5 by means of a barrier which prevents said light-generating substances, which migrate owing to heating upon switching-on of the lamp, from reaching these entry locations 7 in a substantial quantity and subsequently being able to enter the pinches.

The dimensions of this barrier are dependent on the quantity of light-generating substances collected on the bottom region 10 in the switched-off state of the lamp. A possible excess quantity of these substances introduced into the discharge vessel should also be taken into account, which excess quantity is not present as a vapor during lamp operation but as a pool of molten salt.

The barrier may accordingly be formed by a collector reservoir 11 which surrounds the bottom region 10 and is designed to hold the light-generating substances and/or by a sufficiently great height of the entry locations 7 with respect to the bottom region 10, so that the light-generating substances cannot reach the entry locations, at least not in substantial quantities. Said height is determined here by the position and slope of the electrodes 3 as shown in FIGS. 1 and 2.

An advantage of the collector reservoir 11, which may be formed, for example, by a sufficiently large bottom surface area (with or without depression), is furthermore also that it has the effect of keeping the light-generating substances present in the molten salt in the operational state of the lamp substantially far removed from the region of the arc discharge 2, so that the light emission is not interfered with.

It may be achieved in all embodiments by means of an additional coating, which reflects incident infrared radiation and which is provided on the outside of the discharge vessel opposite the bottom region 10, that the temperature of the bottom region and of the light-generating substances accumulated thereon is raised still further and more homogeneously, because the infrared radiation will pass through these regions twice (once before and once after its reflection).

The coating may be formed substantially from zirconium oxide (ZrO₂). Alternative materials may also be used such as, for example, Nb₂O₅ and Ta₂O₅, which have an even better infrared reflectivity than ZrO₂, but which are comparatively expensive. The use of SiO₂ in crystalline form, finally, would also be possible.

Such a coating may be provided in all embodiments also on the exterior of the pinches 5 and of the discharge vessel 1 in those regions in which the entry locations 7 of the electrodes into the pinches 5 are present, so as to contribute to the effect that as few as possible light-generating substances—or other deposited substances—migrate into these entry locations 7 upon switching-on of the lamp.

A luminous efficacy and/or burning voltage satisfactory for certain applications may possibly also be achieved when mercury is left out without replacement, i.e. no voltage-gradient generator is used, or certain quantities of rare gases (for example xenon) are introduced into the discharge space as an alternative to the voltage-gradient generators so as to raise the gas pressure.

It should finally be noted that the principle of the invention, by which the temperature of the lower regions of the discharge vessel is raised, is also applicable to lamps which do contain mercury and in which the environmental disadvantages inherent in mercury are accepted. In this case, such a temperature rise may serve, for example, to increase the luminous efficacy or, for a given luminous efficacy, to reduce the input power of the lamp.

1. A mercury-free high-pressure gas discharge lamp with a discharge vessel (1), with pinches (5), and with at least one metal foil (4) of which a portion extends in vertical direction when the lamp is in the horizontal operational position and to which an electrode (3) is fastened, wherein the distance from the electrode tip to a bottom region (10) of the discharge vessel (1), on which light-generating substances accumulate in the switched-off state of the lamp, is dimensioned such that said substances enter the gas phase in a sufficient quantity owing to heating upon switching-on of the lamp.

2. A high-pressure gas discharge lamp as claimed in claim 1, wherein the discharge vessel (1) comprises a barrier (11) against light-generating substances which migrate in the direction of entry locations (7) of the electrodes (3) into the pinches (5) owing to the heating.

3. A high-pressure gas discharge lamp as claimed in claim 2, wherein the barrier is formed by a collector reservoir (11) for migrating light-generating substances, which reservoir surrounds the bottom region (10), and/or by a sufficient height of the entry locations (7) above the bottom region (10).

4. A high-pressure gas discharge lamp as claimed in claim 1, wherein at least one of the electrodes (3) is fastened to the metal foil (4) parallel to a horizontal line of symmetry of the lamp but in a position shifted in downward direction.

5. A high-pressure gas discharge lamp as claimed in claim 1, wherein at least one of the electrodes (3) is fastened to the metal foil (4) so as to point obliquely downwards.

6. A high-pressure gas discharge lamp as claimed in claim 1, wherein the distance of at least one of the electrode tips to the bottom region (10) is dimensioned such that a substantially homogeneous or symmetrical temperature distribution arises in the discharge vessel (1) in the operational state of the lamp.

7. A high-pressure gas discharge lamp as claimed in claim 1, which has a voltage-gradient generator in the form of one or several metal halides in its gas filling.

8. A high-pressure gas discharge lamp as claimed in claim 1, wherein the gas filling comprises additional quantities of rare gases, such as xenon, for increasing the gas pressure, the luminous efficacy, and/or the burning voltage of the lamp.

9. A high-pressure gas discharge lamp as claimed in claim 1, wherein the outer wall of the discharge vessel (1) is provided with a coating comprising zirconium oxide (ZrO₂) in the regions of entry locations (7) of the electrodes (3) into the pinches (5) and of the pinches (5) themselves.

10. A lighting unit, in particular for motor vehicle headlights, comprising a high-pressure gas discharge lamp as claimed in claim 1.
